(19) United States
(12) Patent Application Publication
(10) Pub. No.: US 2009/0151873 A1
(43) Pub. Date: Jun. 18, 2009

(54) SLEEVELESS TIRE BUILDING DRUM

(76) Inventors: Ricardo de Mello Pinto, Akron, OH (US); Cesar Nazare de Oliveira, Jd. Sta. Catarina- SP (BR); Jose Luiz de Souza, Jd. Ipiranga (BR); Luis Carlos Gentil, Anavec. Limeira-SP (BR)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/255,729

(22) Filed: Oct. 22, 2008

Related U.S. Application Data
(63) Continuation of application No. 61/014,553, filed on Dec. 18, 2007.

(51) Int. Cl. B29D 30/24

(52) U.S. Cl. 156/416; 156/414

(57) ABSTRACT

The invention provides in a first aspect a method of converting a tire building drum into a sleeveless tire building drum. The method comprising the steps of providing a tire building drum having a center sleeve, removing the center sleeve, providing a plurality of cover plates and a plurality of segments located underneath the coverplates, the segments connected to radially oriented pistons for radial movement of the center section; Providing a plurality of holes on said coverplates, connected the holes to a fluid manifold, and connecting the manifold to a vacuum source. The invention provides in a second aspect, a sleeveless tire building drum which includes a rotatable drum comprising a left and right section and a center section. The center section is radially expandable, and the left and right sections are axially movable. The center section has a plurality of coverplates mounted on the circumference of the center section, the coverplates having an outer surface having a plurality of holes, and a inner surface having a manifold connected to the plurality of holes, said manifold connected to a vacuum source, wherein the center section of the tire building drum does not have an outer sleeve.

This application claims the benefit of, and incorporates by reference U.S. Provisional Application No. 61/014,553 filed Dec. 18, 2007.

### FIELD OF THE INVENTION

The invention relates to tire building machinery, and more particularly, to tire building drums, and a method of manufacturing a sleeveless drum.

### BACKGROUND OF THE INVENTION

Prior art tire building drums 10 such as shown in FIG. 1 typically have a center section 15 in the middle of two end sections 20, 22. The center section 15 is covered with a rubber coated sleeve 16 that has ends that are anchored in the center section 15 (not shown). The end sections 20, 22 are typically axially movable away from the center section. Each tire has on its particular building specification a first position axial width, which may vary according to tire size, as shown in Table I. Even for same tire rim diameter, the sleeve may need to be changed out. In order to accommodate different tire sizes, the central sleeve is generally changed out with a different size central sleeve. This change out results in lost productivity and cost. Thus an improved method and apparatus is desired which would reduce or eliminate the lost productivity due to the changeout of the central sleeve. It is desired to also have an improved method of modifying a conventional tire building drum to remove the center sleeve.

### SUMMARY OF THE INVENTION

The invention provides in a first aspect a method of converting a tire building drum having a sleeve into a sleeveless tire building drum. The method comprising the steps of providing a tire building drum having a center sleeve, removing the center sleeve, providing a plurality of cover plates and a plurality of segments located underneath the coverplates, the segments connected to radially oriented pistons for radial movement of the center section; Providing a plurality of holes on said coverplates, connected the holes to a fluid manifold, and connecting the manifold to a vacuum source.

The invention provides in a second aspect, a sleeveless tire building drum which includes a rotatable drum comprising a left and right section and a center section. The center section is radially expandable, and the left and right sections are axially movable. The center section has a plurality of coverplates mounted on the circumference of the center section, the coverplates having an outer surface having a plurality of holes, and a inner surface having a manifold connected to the plurality of holes, said manifold connected to a vacuum source, wherein the center section of the tire building drum does not have an outer sleeve.

### Definitions

“Aspect Ratio” means the ratio of a tire's section height to its section width.

“Axial” and “axially” means the lines or directions that are parallel to the axis of rotation of the tire.

Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

### BRIEF DESCRIPTION OF THE DRAWINGS

The invention will be described by way of example and with reference to the accompanying drawings in which:

FIG. 1 is a front view of a prior art tire building drum;

FIG. 2 is a front perspective view of a sleeveless tire building drum of the present invention;

FIG. 3 is a front view of the center section of the tire building drum;

FIG. 4 is a front view of the center section of the tire building drum with the coverplate and a portion of the segment plates removed;

FIG. 5A is a front view of a piston chock;

FIG. 5B is a front view of a piston chock and piston;

FIG. 6a illustrates a close up view of the piston flanges located on the center section without a filler ring;

FIG. 6B illustrates a filler ring;

FIG. 6C illustrates the piston flanges located on the center section with a filler ring;

FIG. 7A illustrates a prior art coverplate;

FIG. 7B illustrates a coverplate of the present invention;

FIG. 7C illustrates the rear view of the coverplate of FIG. 7B shown with the manifold and fluid ports for vacuum;

FIG. 8A illustrates lateral segments of the prior art;

FIG. 8B illustrates modified segments having elongated axial slots;

FIG. 8C illustrates a rear view of a coverplate and segments assembly.

### DETAILED DESCRIPTION OF THE INVENTION

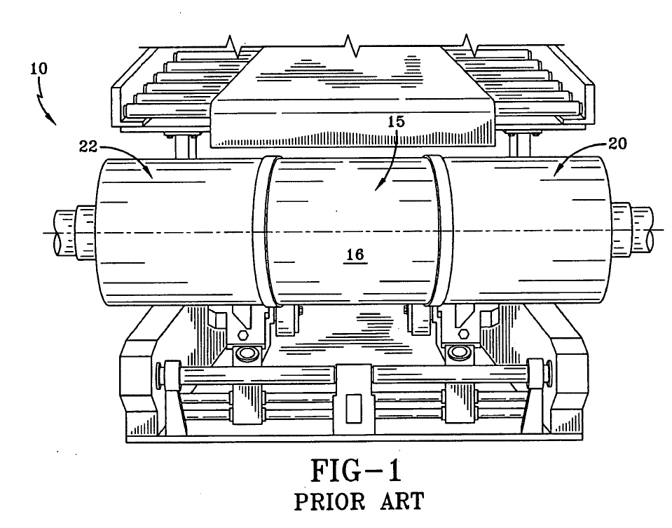

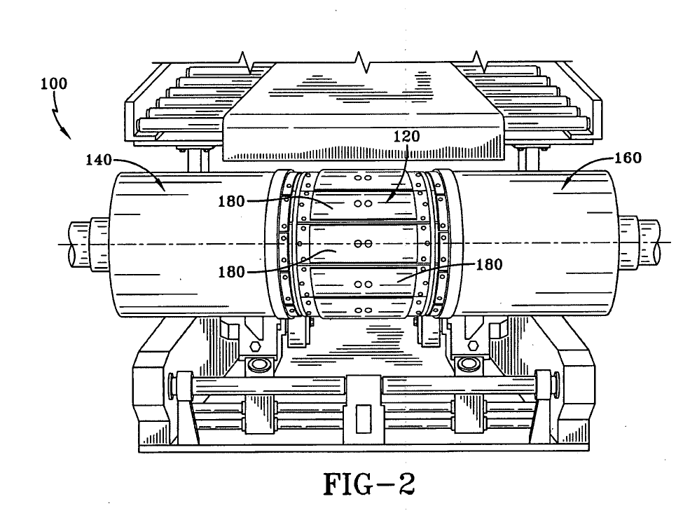

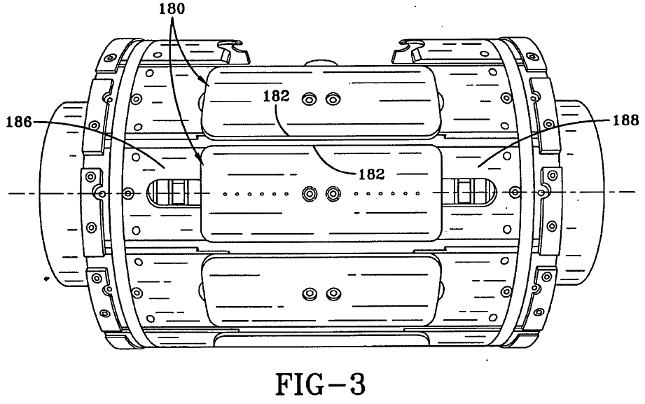

A first embodiment of a sleeveless tire building drum 100 is shown in FIG. 2. The sleeveless tire building drum 100 may be derived from a conventional prior art tire building drum such as shown in FIG. 1, utilizing the following method steps of the present invention. For some tire building applications, the center sleeve's dominant function is to create vacuum on the first stage drum, and hold the rubber components in place during assembly. The inventors have found a way to eliminate the sleeve, while retaining the functionality of the vacuum function. The new drum has the added benefit of not requiring the changing of the center portion sleeve with different size tires.

As shown in FIG. 2, a tire building drum of the present invention includes a cylindrical shaped drum 100. The tire drum is rotatable about its longitudinal axis. The tire drum has a center portion 120 for receiving successive layers of tire building components such as an inner liner, side walls, chafers, breakers, apexes, ply and beads. Preferably for this application, the inner liner is preassembled to the ply. The center portion 120 is also preferably adapted to expand radially outward, in order to tighten up the tire building components over the wire beads and to turn up the ends over the beads. The tire drum further comprises a left portion 140 of the drum and a right portion 160 of the drum located on either end of the center portion 120. The left portion 140 and the right portion 160 may articulate in the axial direction, moving towards and away from the center portion 120 with conventional internal mechanisms (not shown).

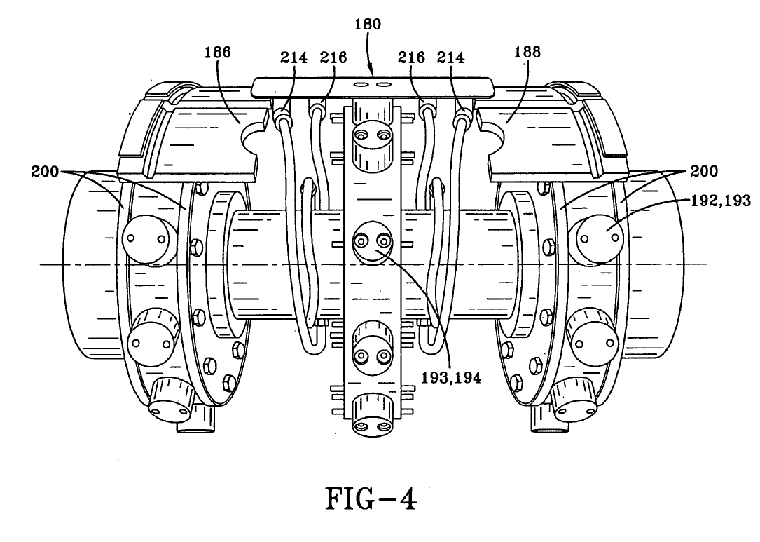

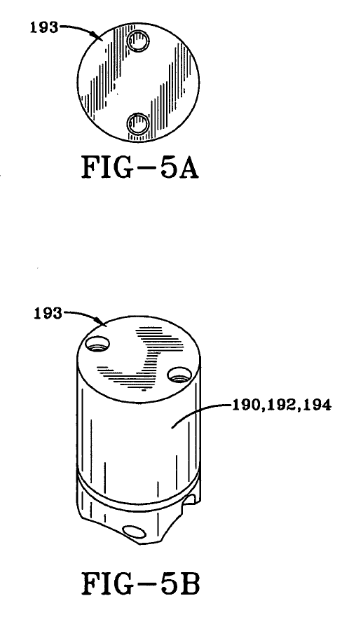

In order to alter a conventional tire building drum with a center sleeve to a sleeveless drum, the first step is to remove the center sleeve from the center section 120 (not shown). When the sleeve is removed, a plurality of coverplates 180 are exposed. The coverplates are generally rectangular and are arranged about the center portion of the drum circumferentially. The lateral edges 182 of the coverplates are in abutting relationship about the circumference of the drum. As shown in FIG. 4, underneath each coverplate is a left and right segment 186,188. The left and right segments 186,188 are connected to a plurality of pistons 190,192,194 arranged about the circumference of the tire building drum, typically at two or more locations, more preferably three. Thus there are an array of left and right lateral pistons 190,192. More preferably there is an array of center pistons 194. The pistons allow the center section to radially expand. In order to compensate for the loss of diameter when the drum is radially expanded due to the removal of the center sleeve, circular piston chocks 193 were placed on top of all of the pistons, at all locations. The piston chocks as shown in FIG. 5, are round spacers placed on top of each piston adding radial height in order to compensate for loss in diameter due to sleeve removal.

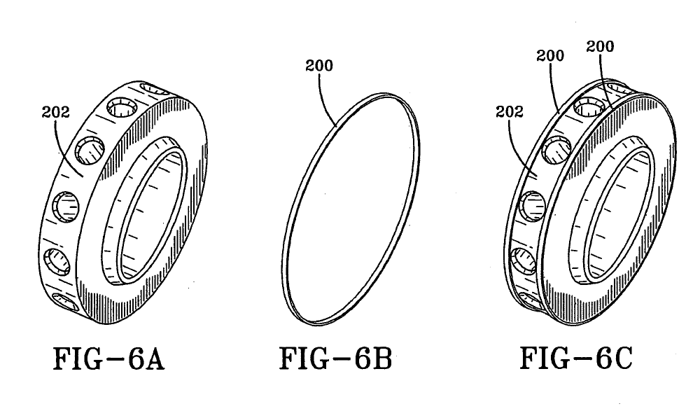

Next, filler rings 200 are added to the center section, one the left and right side, adjacent left and right flanges 202,204 that house pistons 190,192. FIG. 6A illustrates the piston flanges without the rings. FIG. 6B illustrates a filler ring 200, and FIG. 6C illustrates the filler rings 200 on each side of flange 202. The filler rings 200 compensate for the loss in axial width due to removal of the sleeve.

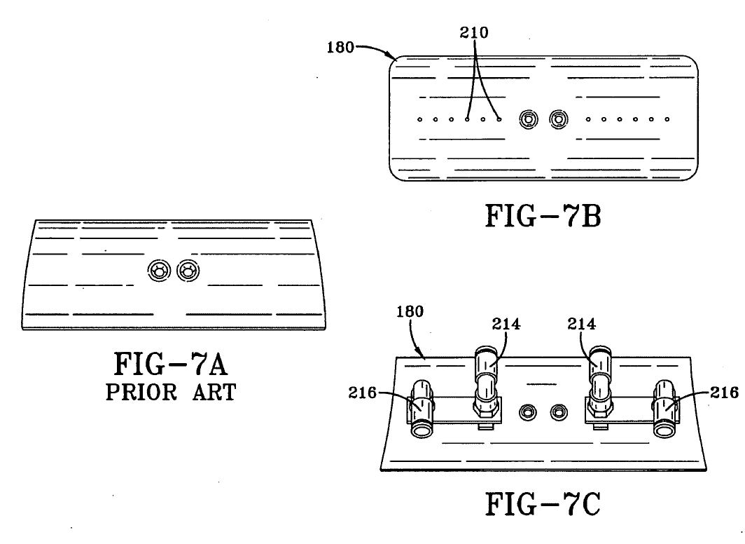

Next, the coverplates 180 are modified such that there are a plurality of small holes on the front face of the plate for the purpose of supplying a vacuum. FIG. 7a illustrates the prior art coverplate, while FIG. 7b illustrates two sets of additional holes 210 added to the coverplate 180. Each set is connected to a manifold 212 having fluid an inlet port 214 and an outlet port 216. The inlet port 214 is connected to a vacuum source, which is typically located in the center shaft. The outlet port is connected to an exhaust line, which may be ported through the center shaft.

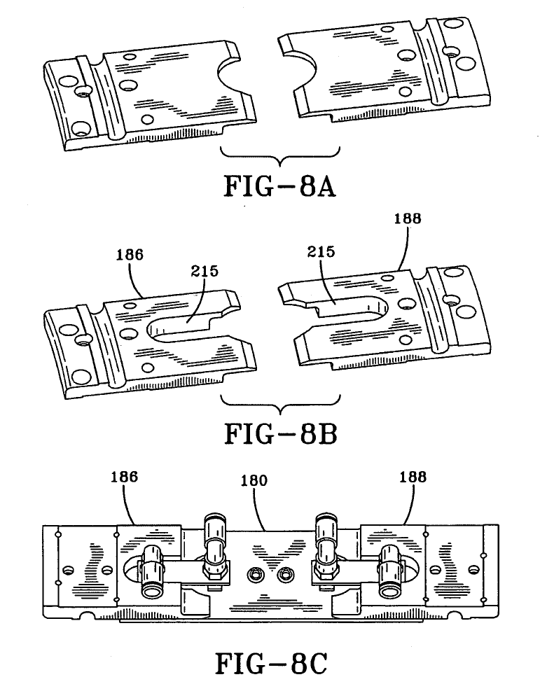

Next, the lateral segments 186,188 were modified as shown in FIG. 8B. FIG. 8A illustrates the lateral segments prior to modification. FIG. 8B illustrates the modified lateral segments, wherein each segment has an axial elongated slot 215 milled therein. The elongated slots 215 allow for axial translation of the center section and to avoid interference with the fluid manifolds 212 and ports 214,216. FIG. 8C illustrate the assembly of the segments 186,188 and the cover plate 180.

The order of the above method steps need not be performed in the order described. The above steps may also be utilized when building a sleeveless building drum.

FIG. 2 illustrates the assembled sleeveless tirebuilding drum of the invention. The outer coverplates 180 provide vacuum on the rubber components via small holes on the outer surface. The coverplates are flush with the outer surface of the drum after the radial height has been compensated for by the piston chocks. The center section of the drum can radially expand as well as axially translate. The axial oriented slots of segments allow the drum to axially contract without interfering with the fluid manifold on the rear of the coverplate. The sleeveless tirebuilding drum of the present invention reduces the need of changing out the sleeve or center section, thus reducing costs and increasing productivity.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of converting a tire building drum into a sleeveless tire building drum, the method comprising the steps of:
Providing a tire building drum having a center sleeve, and a plurality of cover plates and a plurality of segments located underneath the coverplates, the segments connected to radially oriented pistons for radial movement of the center section;
Removing the center sleeve;
Providing a plurality of holes on said coverplates, connected the holes to a fluid manifold, connecting the manifold to a vacuum source.

2. The method of claim 1 wherein a plurality of spacer plates are added to the pistons.

3. The method of claim 1 wherein the lateral segments have elongated slots therein for receiving the fluid manifold connected to the coverplates.

4. A sleeveless tire building drum comprising:
A rotatable drum comprising a left and right section and a center section, the center section being radially expandable, and the left and right section being axially movable, the center section having a plurality of coverplates mounted on the circumference of the center section, the coverplates having an outer surface having a plurality of holes, and a inner surface having a manifold connected to the plurality of holes, said manifold connected to a vacuum source, wherein the center section of the tire building drum does not have an outer sleeve.

5. The tire building drum of claim 4 further comprising a plurality of segments mounted under the coverplate, wherein each segment has an axially oriented slot.
